(19) United States
(12) Patent Application Publication
(10) Pub. No.: US 2006/0286941 A1
(43) Pub. Date: Dec. 21, 2006

(54) Selection of antenna patterns

(75) Inventor: Cyrus Behroozi, Menlo Park, CA (US)

Correspondence Address: Tropos Networks Patent Department, P.O. Box 641867, San Jose, CA, 95164-1867, US

(73) Assignee: Tropos Networks

(21) Appl. No.: 11/156,121

(22) Filed: Jun. 17, 2005

(51) Int. Cl. H04B 1/44

(52) U.S. Cl. 455/78

(57) ABSTRACT

A wireless transceiver is disclosed. The wireless transceiver includes an antenna having an adjustable setting to perturb an antenna pattern of the antenna. A receive/transmit signal quality is determined for all available antenna patterns, and the adjustable setting is selected to provides the best signal quality. For an embodiment, the antenna comprises a plurality of feed points, and the adjustable settings include selecting settings of a switch that connects to each of the feed points.

### FIELD OF THE INVENTION

The invention relates generally to wireless communication. More particularly, the invention relates to an apparatus and method for selecting one of multiple antenna patterns.

### BACKGROUND OF THE INVENTION

Wireless systems include wireless links that are typically subject to environmental conditions that influence performance of the wireless links of the wireless systems. The environmental conditions include signal interference, transmission signal attenuation and transmission signal multi-path propagation. Typically, the environmental conditions vary over time.

FIG. 1 shows a prior art wireless link between a first transceiver 110 having a first antenna 150 and a second transceiver 120 having a second antenna 160. Wireless links between transceivers typically include more than a single transmission path. That is, typically, the transmission signal travels more than one path (Path1, Path2) between the first transceiver and the second transceiver. The phenomena referred to as “multi-path propagation” can cause fading of the of the transmission signals if signals of multiple paths sum in a way that acts to cancel the received transmission signal energy of the individual signals.

FIG. 2 shows a prior art multiple antenna spatial diversity wireless communications link. The transceiver 220 of FIG. 2 includes multiple (two) spatially separate antennas (Antenna1, Antenna2). The two antennas can be used to reduce the effects of multi-path propagation of transmission signals between the two transceivers 110, 220. The second transceiver 220 can test or monitor the signal quality of transmission signals through each of the two antennas. Typically, one antenna will suffer less from the effects of multi-path propagation because fading typically varies from one spatial location to another. The antenna that provides the best quality transmission signals can be selected for use. This process is generally referred to as antenna selection diversity.

Multiple antenna spatial diversity can include multiple antennas at the transmitter (transmit diversity), multiple antennas at the receiver (receiver diversity), or multiple antennas at both the transmitter and the receiver. Antenna selection diversity can be used at either the transmitter or the receiver.

A limitation to multiple antenna spatial diversity systems is the requirement of multiple antennas. Transceivers that include multiple antennas are typically more expensive, and more difficult to manufacture.

It is desirable to have a transceiver benefiting from the advantages gained from spatially separate antennas without actually having multiple antennas.

### SUMMARY OF THE INVENTION

An embodiment of the invention includes a wireless transceiver. The wireless transceiver includes an antenna having an adjustable setting to perturb an antenna pattern of the antenna. A receive/transmit signal quality is determined for all available antenna patterns, and the adjustable setting is selected to provide the best signal quality. For an embodiment, the antenna comprises a plurality of feed points, and the adjustable settings include selecting settings of a switch that connects to each of the feed points.

Another embodiment of the invention includes a method of controlling a multiple feed point antenna. The method includes setting a switch to a first feed point, testing signal quality of transmit signals of the first feed point, setting the switch to a second feed point, testing signal quality of transmit signals of the second feed point, and selecting the switch setting corresponding to the one of the first and second feed points having the best signal quality.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless communication link.

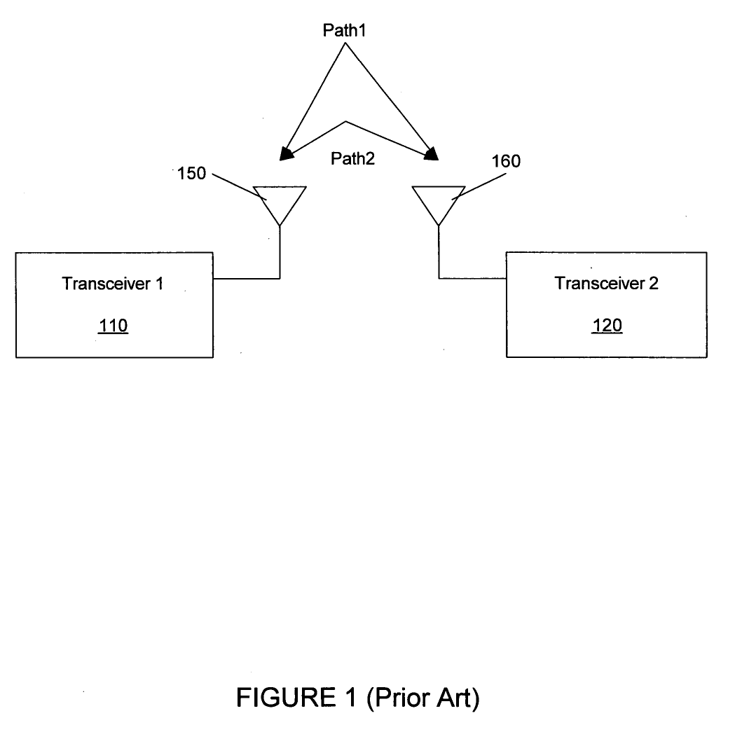

FIG. 2 shows a prior art multiple antenna spatial diversity wireless communications link.

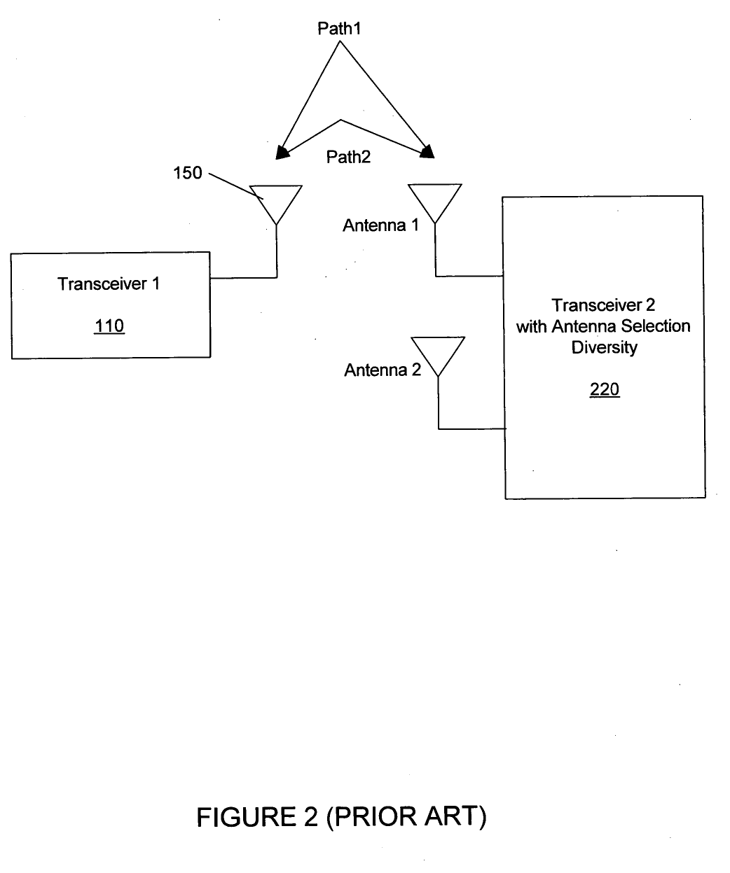

FIG. 3 shows a wireless transceiver that includes an antenna having two feed points.

FIG. 4 shows a wireless transceiver that includes multiple antennas, in which at least one of the antennas includes multiple feed points.

FIG. 5 shows a wireless transceiver that includes an antenna having multiple feed points.

FIG. 6 shows a wireless transceiver that includes a multiple-feed point, dipole element antenna.

FIG. 7 is a flow chart that includes steps for selecting a feed point of a multiple feed point antenna.

FIG. 8 shows a low frequency block for providing a control signal for a switch of a multiple feed point antenna.

### DETAILED DESCRIPTION

The invention includes an apparatus and method of selecting a desired antenna pattern from a plurality of available antenna patterns, for a wireless transceiver. One embodiment includes selecting one of multiple feed points connected to the antenna, the selection based upon transmission signal quality.

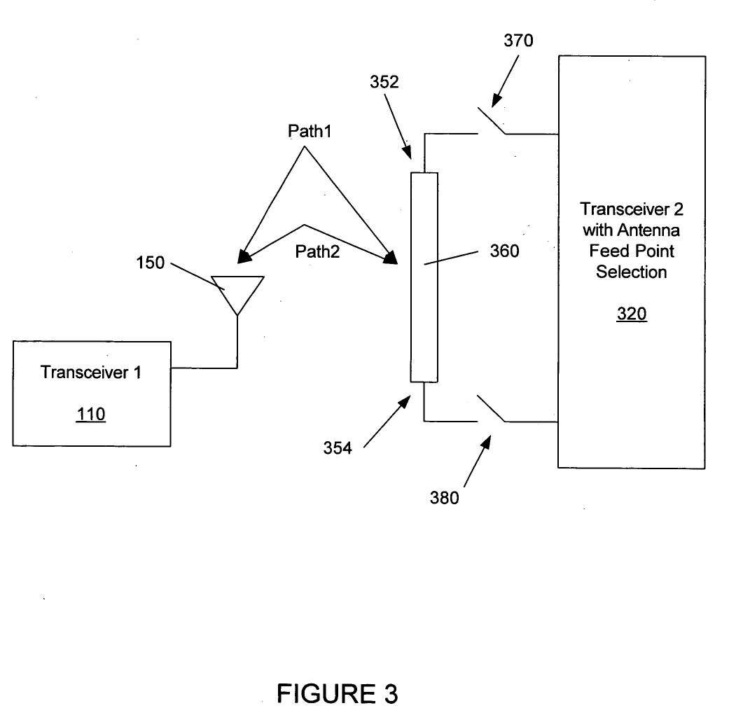

FIG. 3 shows a wireless transceiver 320 that includes an antenna 360 having two feed points 352, 354. The feed points 352, 354 are connected to the electronic circuitry of the transceiver 320 through one or more switches 370, 380. The antenna 360 (which can, for example, include multiple dipole elements) includes multiple antenna patterns corresponding to each of the feed points 352, 354. That is, the antenna pattern of the antenna 360 is dependent upon which feed point of the antenna 360 is in use (connected to the transceiver 320).

The switches 370, 380 can alternatively be implemented with a single switch that connects directly to the feed points 352, 354 of the antenna 360. The switch or switches 352, 354 can be included within the transceiver 320.

The multiple antenna patterns of the multiple feed points 352, 354 can be used to effectively provide spatial diversity with a single antenna. That is, spatial diversity typically includes multiple spatially separate antennas that transmit and/or receive transmission signals with another antenna (physically located, for example, with another transceiver). A one of the spatially separate antennas can be selected for communication depending upon which of the spatially separate antennas provides the best communication path with the other antenna. Similarly, connection to each of the separate feed points 352,354 of an antenna provides a slightly different antenna pattern corresponding with each separate feed point. A one of the separate feed points 352, 354 can be selected for communication depending upon which of the separate feed points provides the best communication path with the other antenna (for example, antenna 150).

Signal quality of transmission signals for each feed point 352, 354 can be measured or characterized. The selected feed point can be the feed point that provides transmission signals having the best signal quality, as determined by measuring or estimating the SNR, BER or PER of the transmission signals. Methods for measuring signal quality of wireless signals are known by those skilled in the art of wireless communications.

The transmission signal quality for each of the feed points can vary over time. Therefore, the selection process can be repeated over time. The selection process can be repeated periodically, or a degradation of transmission signal quality of a previously selected feed point can trigger the reselection process.

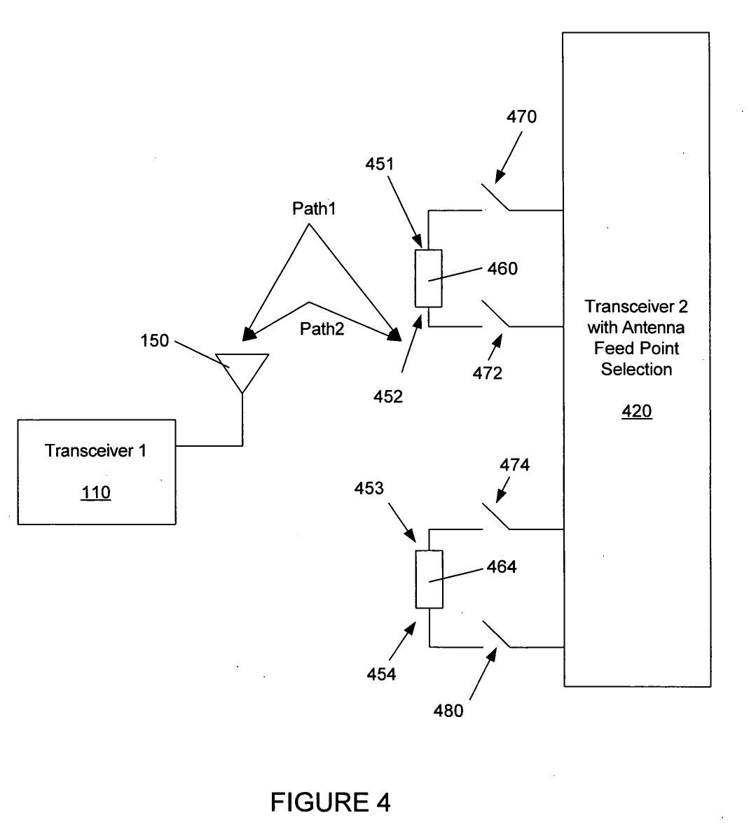

FIG. 4 shows a wireless transceiver 420 that includes a multiple antennas 460, 464 having multiple feed points 451, 452, 453, 454. FIG. 4 shows that the antenna configuration of FIG. 3, can be used in a multiple antenna system, such as, a multiple input, multiple output (MIMO) system. MIMO systems can provide spatial multiplexing and communication diversity for improvement of data transmission rates and quality. The inclusion of antennas with multiple feed points allows an additional improvement in transmission signal quality not available in standard MIMO systems, thereby allowing in some situations, a reduction in the number of antennas required. MIMO systems are typically very expensive due to the multiple antennas that can exist at both transmitter and receiver ends of wireless communication. The multiple feed points provide additional antenna patterns not available with single feed point antennas. The optimal antenna pattern can be selected for transmission signal quality optimization.

The feed points 451, 452, 453, 454 can be connected to other circuitry of the transceiver 420 through switches 470, 472, 474, 480. As previously mentioned, other switch configurations can accomplish the same functionality.

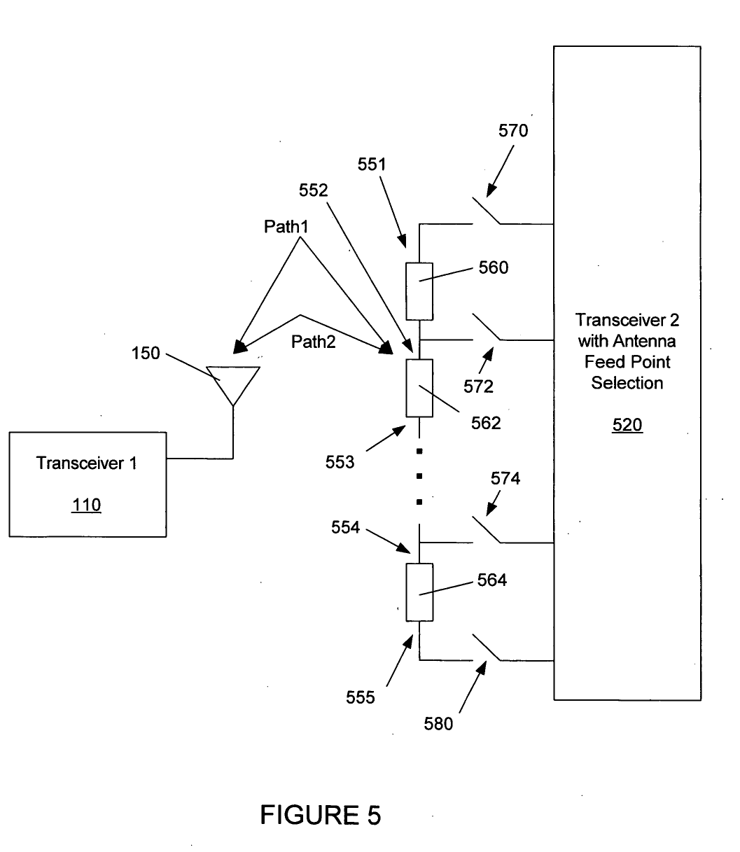

FIG. 5 shows a wireless transceiver that includes an antenna having multiple feed points 551, 552, 553, 554, 555. The feed points of the multiple element antenna can be included between each of the antenna elements 560, 562, 564. Each of the antenna elements can include, for example, a multiple element dipole antenna element. Each feed point 551, 552, 553, 554, 555, included between each of the antenna elements provides an antenna pattern that is unique to the feed point. The inclusion of multiple feed points 551, 552, 553, 554, 555 between the antenna elements allows for selection of the antenna pattern that provides that best transmission signal quality. Feed point selection is made by controlling switches 570, 572, 574, 580. The multiple feed point antenna of FIG. 5 can also be included within a MIMO antenna system as shown in FIG. 4.

The feed points 551, 552, 553, 554, 555 can be connected to other circuitry of the transceiver 520 through switches 570, 572, 574, 580. As previously mentioned, other switch configurations can accomplish the same functionality.

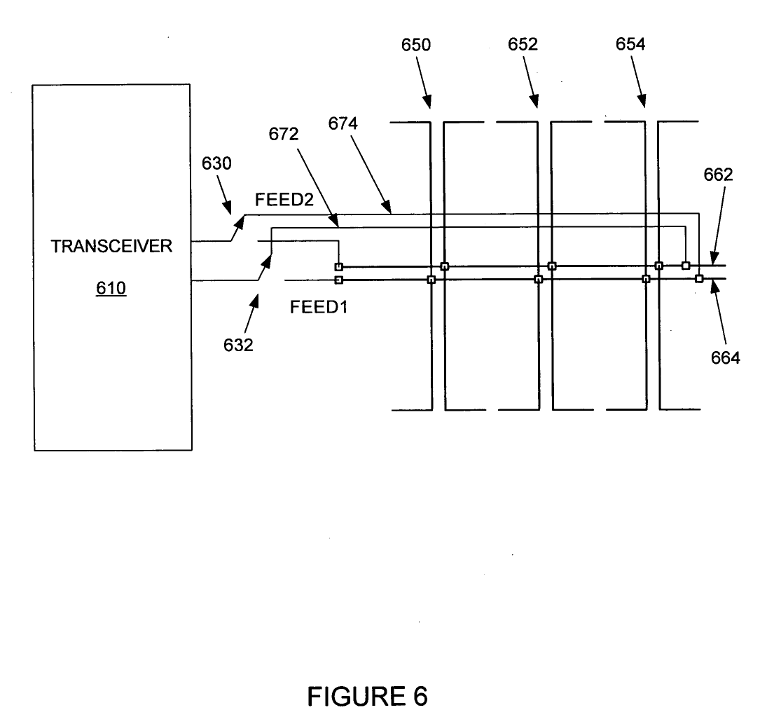

FIG. 6 shows a wireless transceiver 610 that includes a multiple-feed point, dipole element antenna. This multiple element dipole antenna is an example of one embodiment of a multiple feed antenna. The multiple element dipole antenna includes antenna center conductors 662, 664 that are electrically connected to dipole elements 650, 652, 654.

Switches 630, 632, provide connection of the transceiver 610 to a first feed point (FEED1) and a second feed point (FEED2). The first feed point can be physically located at one end of the antenna, and the second feed point can be physically located at another end of the antenna. The second feed point is connected to conductive lines 672, 674 which span the length of the antenna to connect with the switches 630, 632.

A desirable feature of the antenna configuration of FIG. 6, is that the conductive lines (second switch conductors) 672, 674 can be fabricated to extend along the antenna center conductors 663, 664. If, for example, the antenna is connected to the transceiver 610 at the same end as the first feed point, the connection to the second feed point through the conductive lines 672, 674 can be conveniently manufactured. That is, the switches and the antenna connection to the transceiver 610 are all proximate, making them easier to fabricate into an easily connectable unit.

The multiple-feed point multiple element dipole antenna of FIG. 6 can be manufactured on printed circuit board for a wide range of frequency bands. This allows for the antenna to be easily manufactured. As shown in FIG. 6, both the antenna center conductors and the conductive lines (switch conductors) extend along length of the multiple-feed point dipole antenna.

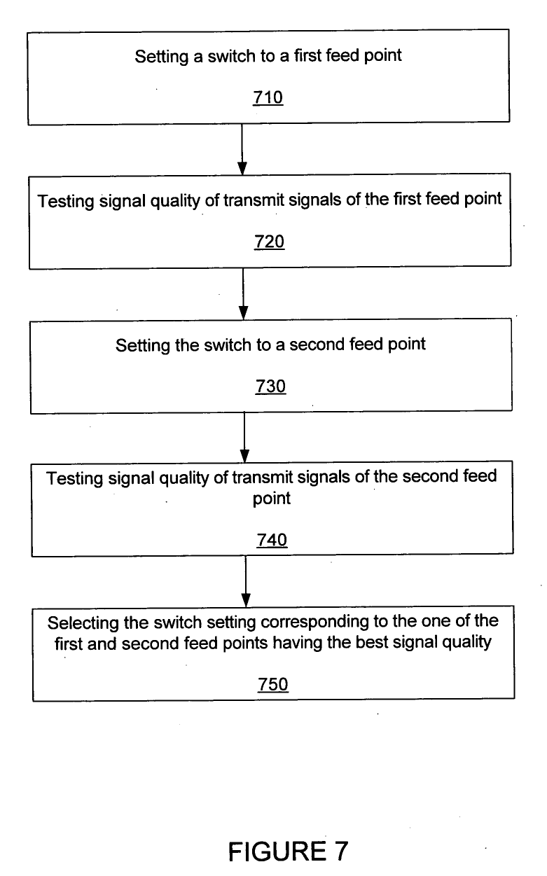

FIG. 7 is a flow chart that includes steps for selecting a feed point of a multiple feed point antenna. A first step 710 includes setting a switch to a first feed point. A second step 720 includes testing signal quality of transmit signals of the first feed point. A third step 730 includes setting the switch to a second feed point. A fourth step 740 includes testing signal quality of transmit signals of the second feed point. A fifth step 750 includes selecting the switch setting corresponding to the one of the first and second feed points having the best signal quality.

The signal quality can be evaluated during a first portion (often referred to as the preamble) of every data frame. Additionally, or alternatively, the signal quality can be adaptively monitored depending upon a measured signal to noise ratio or packet error rate of the transmission signals.

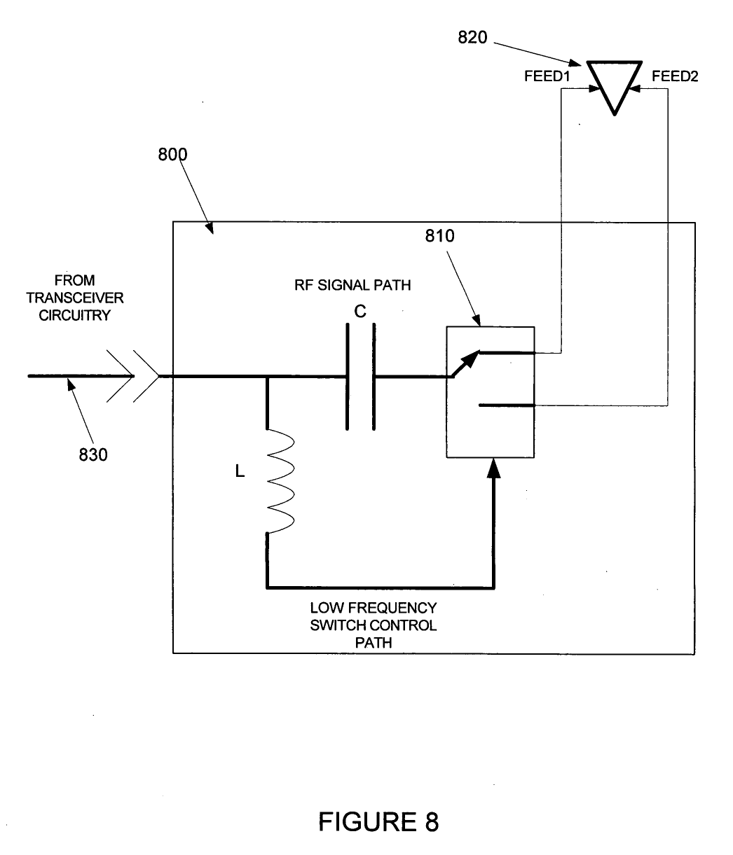

FIG. 8 shows a low frequency block 800 for providing a control signal for a switch of a multiple feed point antenna. It is desirable to minimize the number of physical connections between a transceiver and multiple feed point antenna 820. The low frequency block 800 allows the transceiver to control a switch 810 that provides connections to the first feed point (FEED1) and the second feed point (FEED2) of the antenna, and to couple transmission signals to the antenna 820, with a single electrical connection 830. The single electrical connection 830 of the transceiver is connected to the low frequency block 800, which separates low frequency switch control from RF communications signals.

Here, the exemplary low frequency block 800 includes a high-pass filter, formed by a capacitor C1, between the input of the low frequency block 800 and one output connected to one input of the switch 830. The exemplary low frequency block 800 also includes a low-pass filter, formed by inductor L1, between the input of the low frequency block 800, and a switch control output.

The low frequency block 800 shown in FIG. 8 is exemplary. That is, other circuit configurations could provide the same essential functionality of separating low frequency and high frequency signals. The key characteristics are providing a single connection output, and generating two outputs that include low frequency switch control and high frequency transmission signals.

Although specific embodiments of the invention have been described and illustrated, the invention is not to be limited to the specific forms or arrangements of parts so described and illustrated. The invention is limited only by the appended claims.

What is claimed:

1. A wireless transceiver comprising:
an antenna having a plurality of feed points;
a switch for providing a connection to each of the feed points;
means for determining receive/transmit signal quality for signals associated with connection to each of the feed points; wherein
the switch is set to provide connection to the feed point that provides the most desired signal quality.

2. The wireless transceiver of claim 1, further comprising:
a plurality of antennas, each antenna comprising a plurality of feed points; wherein
an antenna connection associated with each antenna is connected to a one of the plurality of feed points.

3. The wireless transceiver of claim 1, the antenna comprises a first end having a first feed point and a second end having a second feed point.

4. The wireless transceiver of claim 3, wherein the switch electrically connects the transceiver to at least one of the first feed point and the second feed point.

5. The wireless transceiver of claim 1, wherein the means for determining receive/transmit signal quality for signals associated with connection to each of the feed points comprises testing signal quality for each setting of the switch, and selecting the setting that provides the best signal quality.

6. The wireless transceiver of claim 5, wherein the receive/transmit signal quality is determined by determining at least one of SNR, BER and PER of the signals associated with connection to each of the feed points.

7. The wireless transceiver of claim 1, further comprising a low frequency block being connected to the switch, the low frequency block separating a low frequency switch control signal from higher frequency transmission signals.

8. The wireless transceiver of claim 7, wherein the low frequency switch control signal controls settings of the switch.

9. The wireless transceiver of claim 3, wherein the antenna comprises a multiple element dipole antenna.

10. The wireless transceiver of claim 9, wherein the multiple element dipole antenna comprises a antenna center conductor, and a switch conductor that extend along a length of the multiple element dipole antenna, the center conductor being connected to dipole elements, and the switch conductor being connected at least one feed point.

11. A method of controlling a multi-feed antenna comprising:
setting a switch to a first feed point;
testing signal quality of transmit signals of the first feed point;
setting the switch to a second feed point;
testing signal quality of transmit signals of the second feed point;
selecting the switch setting corresponding to the one of the first and second feed points having the best signal quality.

12. The method of controlling a multi-feed antenna of claim 11, further comprising:
setting a second switch to a first feed point of a second multi-feed antenna;
testing signal quality of transmit signals of the first feed point of the second multi-feed antenna;
setting the second switch to a second feed point of the second multi-feed antenna;
testing signal quality of transmit signals of the second feed point of the second multi-feed antenna;
selecting the second switch setting corresponding to the one of the first and second feed points having the best signal quality.

13. The method of controlling a multi-feed antenna of claim 11, the antenna comprises a first end having a first feed point and a second end having a second feed point.

14. The method of controlling a multi-feed antenna of claim 13, wherein the switch electrically connects the transceiver to at least one of the first feed point and the second feed point.

15. The method of controlling a multi-feed antenna of claim 5, wherein testing signal quality comprises determining at least one of SNR, BER and PER of the signals associated with connection to each of the feed points.

16. The method of controlling a multi-feed antenna of claim 11, further comprising a low frequency block being connected to the switch, the low frequency block separating a low frequency switch control signal from higher frequency transmission signals.

17. The method of controlling a multi-feed antenna of claim 16, wherein the low frequency switch control signal controls settings of the switch.

18. The method of controlling a multi-feed antenna of claim 12, wherein the antenna comprises a multiple element dipole antenna.

19. The method of controlling a multi-feed antenna of claim 18, wherein the multiple element dipole antenna comprises an antenna center conductor, and a switch conductor that extends along a length of the multiple element dipole antenna, the center conductor being connected to dipole elements, and the switch conductor being connected to at least one feed point.

20. The method of controlling a multi-feed antenna of claim 18, wherein the first feed point is at one end of the multiple element dipole antenna, and the second feed point is at another end of the multiple element dipole antenna.
